(19) United States
(12) Patent Application Publication
(10) Pub. No.: US 2017/0108911 A1
(43) Pub. Date: Apr. 20, 2017

(54) SYSTEM AND METHOD FOR PAGE-BY-PAGE MEMORY CHANNEL INTERLEAVING

(71) Applicant: QUALCOMM INCORPORATED, SAN DIEGO, CA (US)

(72) Inventors: DEXTER TAMIO CHUN, SAN DIEGO, CA (US); YANRU LI, SAN DIEGO, CA (US)

(21) Appl. No.: 14/885,793

(22) Filed: Oct. 16, 2015

(51) Int. Cl. G06F 1/32; G06F 12/10

(52) U.S. Cl. CPC G06F 1/324; G06F 12/1009; G06F 2212/1028

(57) ABSTRACT

Systems and methods are disclosed for providing memory channel interleaving with selective power or performance optimization. One such method comprises configuring a memory address map for two or more memory devices accessed via two or more respective memory channels with an interleaved region and a linear region. The interleaved region comprises an interleaved address space for relatively higher performance tasks. The linear region comprises a linear address space for relatively lower power tasks. A request is received from a process for a virtual memory page. The request comprises a preference for power savings or performance. The virtual memory page is assigned to a free physical page in the linear region or the interleaved region according to the preference for power savings or performance.

### DESCRIPTION OF THE RELATED ART

Many computing devices, including portable computing devices such as mobile phones, include a System on Chip (“SoC”). SoCs are demanding increasing power performance and capacity from memory devices, such as, double data rate (DDR) memory devices. These demands lead to both faster clock speeds and wide busses, which are then typically partitioned into multiple, narrower memory channels in order to remain efficient. Multiple memory channels may be address-interleaved together to uniformly distribute the memory traffic across memory devices and optimize performance. Memory data is uniformly distributed by assigning addresses to alternating memory channels. This technique is commonly referred to as symmetric channel interleaving.

Existing symmetric memory channel interleaving techniques require all of the channels to be activated. For high performance use cases, this is intentional and necessary to achieve the desired level of performance. For low performance use cases, however, this leads to wasted power and inefficiency. Accordingly, there remains a need in the art for improved systems and methods for providing memory channel interleaving.

### SUMMARY OF THE DISCLOSURE

Systems and methods are disclosed for providing memory channel interleaving with selective power or performance optimization. One such method comprises configuring a memory address map for two or more memory devices accessed via two or more respective memory channels with an interleaved region and a linear region. The interleaved region comprises an interleaved address space for relatively higher performance tasks. The linear region comprises a linear address space for relatively lower power tasks. A request is received from a process for a virtual memory page. The request comprises a preference for power savings or performance. The virtual memory page is assigned to a free physical page in the linear region or the interleaved region according to the preference for power savings or performance.

Another embodiment is a system for providing memory channel interleaving with selective power or performance optimization. The system comprises a system on chip (SoC) electrically coupled to two or more memory devices. The SoC comprises a processing device and a memory management unit. The memory management unit comprises logic configured manage a memory address map for the two or more memory devices accessed via two or more respective memory channels with an interleaved region and a linear region. The interleaved region comprises an interleaved address space for relatively higher performance tasks, and the linear region comprises a linear address space for relatively lower power tasks. The memory management unit receives, from a process executing on the processing device, a request for a virtual memory page. The request comprises a preference for power savings or performance. The memory management unit assigns the virtual memory page to a free physical page in the linear region or the interleaved region according to the preference for power savings or performance.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a system for providing page-by-page memory channel interleaving.

FIG. 2 illustrates an exemplary embodiment of a data table comprising a page-by-page assignment of interleave bits.

FIG. 3 is a flowchart illustrating an embodiment of a method implemented in the system of FIG. 1 for providing page-by-page memory channel interleaving.

FIG. 4a is block diagram illustrating an embodiment of a system memory address map for the memory devices in FIG. 1.

FIG. 4b illustrates the operation of the interleaved and linear blocks in the system memory map of FIG. 4a.

FIG. 5 illustrates a more detailed view of the operation of one of the linear blocks of FIG. 4b.

FIG. 6 illustrates a more detailed view of the operation of one of the interleaved blocks of FIG. 4b.

FIG. 7 is a block/flow diagram illustrating an embodiment of the memory channel interleaver of FIG. 1.

FIG. 8 is a flowchart illustrating an embodiment of a method implemented in the system of FIG. 1 for allocating virtual memory pages to the system memory address map of FIGS. 4a & 4b according to assigned interleave bits.

FIG. 9 illustrates an embodiment of a data table for assigning interleave bits to linear or interleaved memory zones.

FIG. 10 illustrates an exemplary data format for incorporating interleave bits in a first-level translation descriptor of a translation lookaside buffer in the memory management unit of FIG. 1.

FIG. 11 is a flowchart illustrating an embodiment of a method for performing a memory transaction in the system of FIG. 1.

FIG. 12 is a block/flow diagram illustrating another embodiment of the memory channel interleaver of FIG. 1.

FIG. 13a is block diagram illustrating an embodiment of a system memory address map comprising a concatenated macro linear block.

FIG. 13b illustrates the operation of the concatenated macro linear block of FIG. 13a.

FIG. 14 is a flowchart illustrating an embodiment of a method for assigning virtual pages to the concatenated macro linear block of FIGS. 13a & 13b.

FIG. 15 is a block diagram of another embodiment of a system for providing memory channel interleaving according to a sliding threshold address.

FIG. 16 illustrates an embodiment of a data table for assigning pages to linear or interleaved regions according to a sliding threshold address.

FIG. 17 is a block/flow diagram illustrating an embodiment of the memory channel interleaver of FIG. 15.

FIG. 18 is block diagram illustrating an embodiment of a system memory address map controlled according to the sliding threshold address.

FIG. 19 is a flowchart illustrating an embodiment of a method implemented in the system of FIG. 15 for allocating memory according to the sliding threshold address.

FIG. 20 is a block diagram of an embodiment of a portable computer device for incorporating the systems and methods of FIGS. 1-19.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone”, “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, or a hand-held computer with a wireless connection or link.

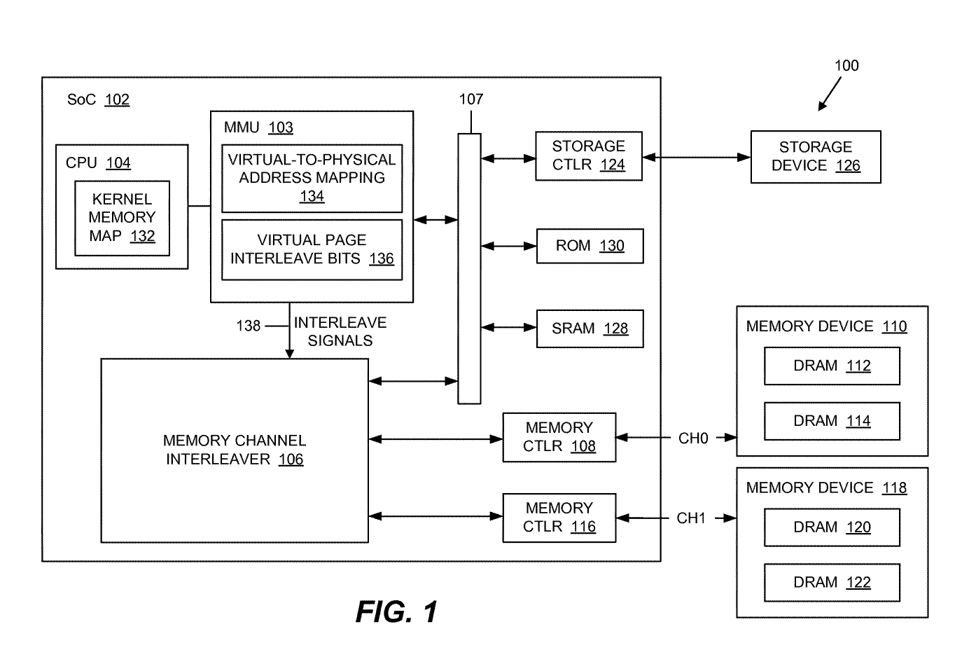

FIG. 1 illustrates a system 100 for providing memory channel interleaving with selective performance or power optimization. The system 100 may be implemented in any computing device, including a personal computer, a workstation, a server, a portable computing device (PCD), such as a cellular telephone, a portable digital assistant (PDA), a portable game console, a palmtop computer, or a tablet computer.

As illustrated in the embodiment of FIG. 1, the system 100 comprises a system on chip (SoC) 102 comprising various on-chip components and various external components connected to the SoC 102. The SoC 102 comprises one or more processing units, a memory management unit (MMU) 103, a memory channel interleaver 106, a storage controller 124, and on-board memory (e.g., a static random access memory (SRAM) 128, read only memory (ROM) 130, etc.) interconnected by a SoC bus 107. The storage controller 124 is electrically connected to and communicates with an external storage device 126. The memory channel interleaver 106 receives read/write memory requests associated with the CPU 104 (or other memory clients) and distributes the memory data between two or more memory controllers, which are connected to respective external memory devices via a dedicated memory channel. In the example of FIG. 1, the system 100 comprises two memory devices 110 and 118. The memory device 110 is connected to the memory controller 108 and communicates via a first memory channel (CH0). The memory device 118 is connected to the memory controller 116 and communicates via a second memory channel (CH1).

It should be appreciated that any number of memory devices, memory controllers, and memory channels may be used in the system 100 with any desirable types, sizes, and configurations of memory (e.g., double data rate (DDR) memory). In the embodiment of FIG. 1, the memory device 110 supported via channel CH0 comprises two dynamic random access memory (DRAM) devices: a DRAM 112 and a DRAM 114. The memory device 118 supported via channel CH1 also comprises two DRAM devices: a DRAM 120 and a DRAM 122.

As described below in more detail, the system 100 provides page-by-page memory channel interleaving. An operating system (O/S) executing on the CPU 104 may employ the MMU 103 on a page-by-page basis to determine whether each page being requested by memory clients from the memory devices 110 and 118 are to be interleaved or mapped in a linear manner. When making requests for virtual memory pages, processes may specify a preference for either interleaved memory or linear memory. The preferences may be specified in real-time and on a page-by-page basis for any memory allocation request.

In an embodiment, the system 100 may control page-by-page memory channel interleaving via the kernel memory map 132, the MMU 103, and the memory channel interleaver 106. It should be appreciated that the term “page” refers to a memory page or a virtual page comprising a fixed-length contiguous block of virtual memory, which may be described by a single entry in a page table. In this manner, the page size (e.g., 4 kbytes) comprises the smallest unit of data for memory management in a virtual memory operating system. To facilitate page-by-page memory channel interleaving, the kernel memory map 132 may comprise data for keeping track of whether pages are assigned to interleaved or linear memory. It should also be appreciated that the MMU 103 provides different levels of memory mapping granularity. The kernel memory map 132 may comprise memory mapping for different level(s) of granularity (e.g., 4 Kbytes page and 64 Kbytes page). The granularity of MMU memory mapping may vary provided the kernel memory map 132 can keep track of the page allocation.

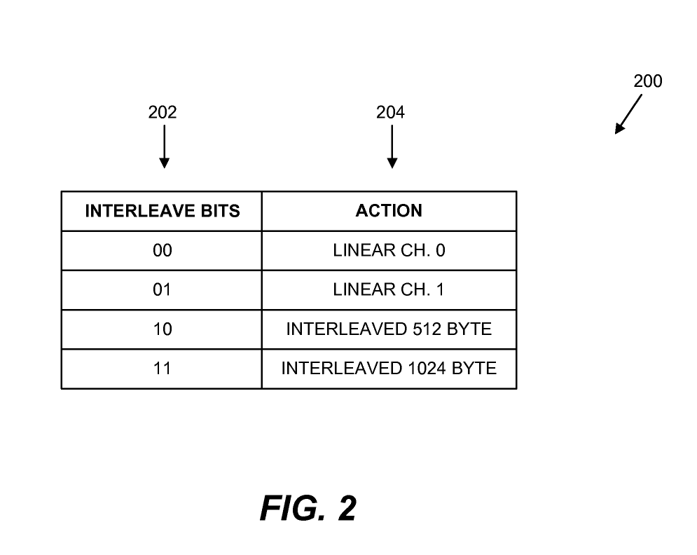

As illustrated in the exemplary table 200 of FIG. 2, the kernel memory map 132 may comprise a 2-bit interleave field 202. Each combination of interleave bits may be used to define a corresponding control action (column 204). The interleave bits may specify whether the corresponding page is to be assigned to one or more linear regions or one or more interleaved regions. In the example of FIG. 2, if the interleave bits are “00”, the corresponding page may be assigned to a first linear channel (CH. 0). If the interleave bits are “01”, the corresponding page may be assigned to a second linear channel (CH. 1). If the interleave bits are “10”, the corresponding page may be assigned to a first interleaved region (e.g., 512 bytes). If the interleave bits are “11”, the corresponding page may be assigned to a second interleaved region (e.g., 1024 bytes). It should be appreciated that the interleave field 202 and the corresponding actions may be modified to accommodate various alternative schemes, actions, number of bits, etc.

The interleave bits may be added to a translation table entry and decoded by the MMU 103. As further illustrated in FIG. 1, the MMU 103 may comprise a virtual page interleave bits block 136, which decodes the interleave bits. For every memory access, the associated interleave bits may be assigned to the corresponding page. The MMU 103 may send the interleave bits via interleave signals 138 to the memory channel interleaver 106, which then performs channel interleaving based upon their value. As known in the art, the MMU 103 may comprise logic and storage (e.g., cache) for performing virtual-to-physical address mapping (block 134).

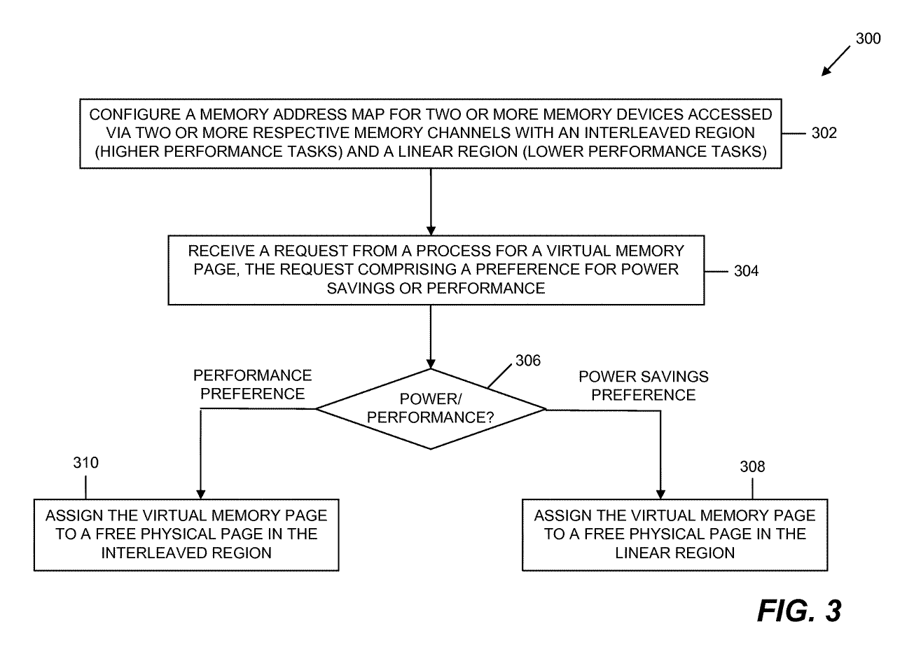

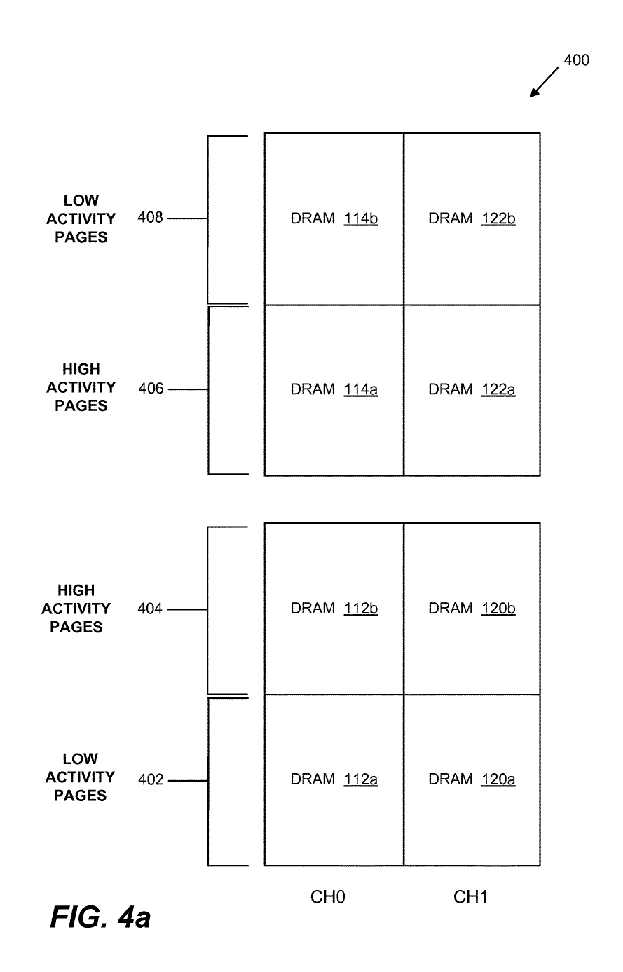

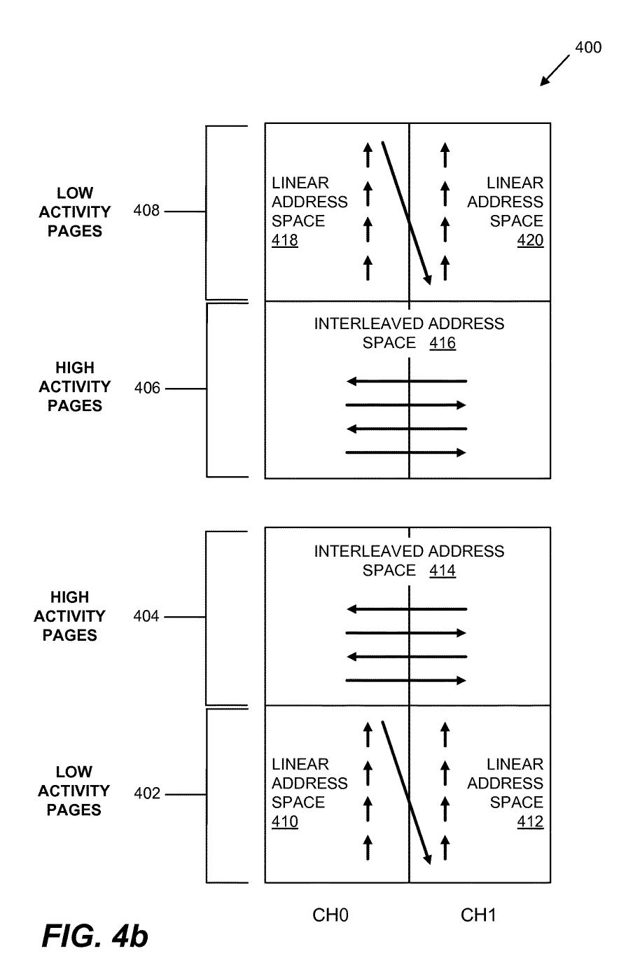

FIG. 3 illustrates an embodiment of a method 300 implemented by the system 100 for providing page-by-page memory channel interleaving. At block 302, a memory address map is configured for two or more memory devices accessed via two or more respective memory channels. A first memory device 110 may be accessed via a first memory channel (CH. 0). A second memory device 118 may be accessed via a second memory channel (CH. 1). The memory address map is configured with one or more interleaved regions for performing relatively higher performance tasks and one or more linear regions for performing relatively lower performance tasks. An exemplary implementation of the memory address map is described below with respect to FIGS. 4a, 4b, 5, and 6. At block 304, a request is received from a process executing on a processing device (e.g., CPU 104) for a virtual memory page. The request may specify a preference, hint, or other information for indicating whether the process prefers to use interleaved or non-interleaved (i.e., linear) memory. The request may be received or otherwise provided to the MMU 103 (or other components) for processing, decoding, and assignment. At decision block 306, if the preference is for performance (e.g., high activity pages), the virtual memory page may be assigned to a free physical page in an interleaved region (block 310). If the preference is for power savings (e.g., low activity pages), the virtual memory page may be assigned to a free physical page in a non-interleaved or linear region (block 308).

FIG. 4a illustrates an exemplary embodiment of a memory address map 400 for the system memory comprising memory devices 110 and 118. As illustrated in FIG. 1, memory device 110 comprises DRAM 112 and DRAM 114. Memory device 118 comprises DRAM 120 and DRAM 122. The system memory may be divided into fixed-size macro blocks of memory. In an embodiment, each macro block comprises 128 MBytes. Each macro block uses the same interleave type (e.g., interleaved 512 bytes, interleaved 1024 bytes, non-interleaved or linear, etc.). Unused memory are not assigned an interleave type.

As illustrated in FIGS. 4a and 4b, the system memory comprises linear regions 402 and 408 and interleaved regions 404 and 406. The linear region 402 and 408 may be used for relatively low power use cases and/or tasks, and the interleaved regions 404 and 406 may be used for relatively high performance use cases and/or tasks. Each region comprises a separate allocated memory address space with a corresponding address range divided between the two memory channels CH0 and CH1. The interleaved regions comprise an interleaved address space, and the linear regions comprise a linear address space.

Linear region 402 comprises a first portion of DRAM 112 (112a) and a first portion of DRAM 120 (120a). DRAM portion 112a defines a linear address space 410 for CH. 0. DRAM 120a defines a linear address space 412 for CH. 1. Interleaved region 404 comprises a second portion of DRAM 112 (112b) and a second portion of DRAM 120 (120b), which defines an interleaved address space 414. In a similar manner, linear region 408 comprises a first portion of DRAM 114 (114b) and a first portion of DRAM 122 (122b). DRAM portion 114b defines a linear address space 418 for CH. 0. DRAM 122b defines a linear address space 420 for CH. 1. Interleaved region 406 comprises a second portion of DRAM 114 (114a) and a second portion of DRAM 122 (122a), which defines an interleaved address space 416.

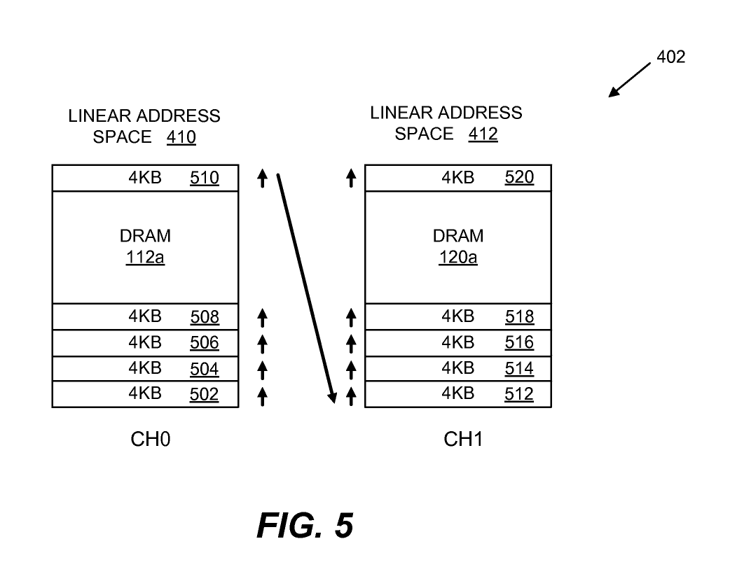

FIG. 5 illustrates a more detailed view of the operation of the linear region 402. The linear region 402 comprises a macro block of separate consecutive memory address ranges within the same channel. A first range of consecutive memory addresses (represented by numerals 502, 504, 506, 508, and 510) may be assigned to DRAM 112a in CH0. A second range of consecutive addresses (represented by numerals 512, 514, 516, 518, and 520) may be assigned to DRAM 120a in CH1. After the last address 510 in DRAM 112a is used, the first address 512 in DRAM 120a may be used. The vertical arrows illustrate that the consecutive addresses are assigned within CH0 until a top or last address in DRAM 112a is reached (address 510). When the last available address in CH0 for the current macro block is reached, the next address may be assigned to the first address 512 of a subsequent macro block in CH1. Then, the allocation scheme follows the consecutive memory addresses in CH1 until a top address is reached (address 520).

In this manner, it should be appreciated that low performance use case data may be contained completely in either channel CH0 or channel CH1. In operation, only one of the channels CH0 and CH1 may be active while the other channel is placed in an inactive or “self-refresh” mode to conserve memory power. This can be extended to any number N memory channels.

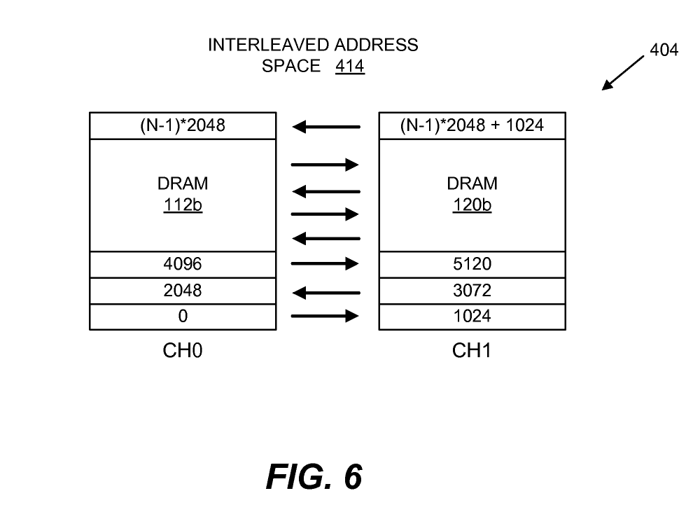

FIG. 6 illustrates a more detailed view of the operation of the interleaved region 404 (interleaved address space 414). In operation, a first address (address 0) may be assigned to a lower address associated with DRAM 112b and memory channel CH0. The next address in the interleaved address range (address 1024) may be assigned to a lower address associated with DRAM 120b and memory channel CH1. In this manner, a pattern of alternating addresses may be “striped” or interleaved across memory channels CH0 and CH1, ascending to top or last addresses associated with DRAM 112b and 120b. The horizontal arrows between channels CH0 and CH1 illustrate how the addresses “ping-pong” between the memory channels. Clients requesting virtual pages (e.g., CPU 104) for reading/writing data to the memory devices may be serviced by both memory channels CH0 and CH1 because the data addresses may be assumed to be random and, therefore, may be uniformly distributed across both channels CH0 and CH1.

In an embodiment, the memory channel interleaver 106 (FIG. 1) may be configured to resolve and perform the interleave type for any macro block in the system memory. A memory allocator may keep track of the interleave types using the interleave bit field 202 (FIG. 2) for each page. The memory allocator may keep track of free pages or holes in all used macro blocks. Memory allocation requests may be fulfilled using free pages from the requested interleave type, as described above. Unused macro blocks may be created for any interleave type, as needed during operation of the system 100. Allocations for a linear type from different processes may attempt to load balance across available channels (e.g., CH0 or CH1). This may minimize performance degradation that could occur if one linear channel needs to service different bandwidth compared to another linear channel. In another embodiment, performance may be balanced using a token tracking scheme where a predetermined quantity of credits are exchanged with each channel to ensure a uniform distribution. After all use cases using a macro block exits, the memory allocator frees all pages within the macro block and returns the macro block to an unassigned state. For example, the interleaved vs. linear attribute may be cleared, and the macro block can be assigned a different attribute when the block is used in the future.

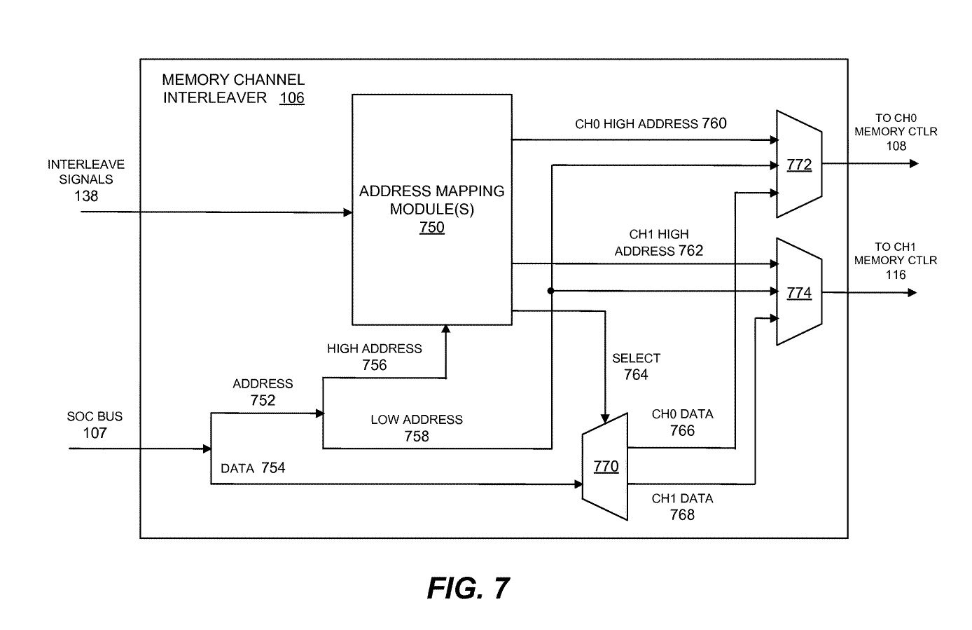

FIG. 7 is a schematic/flow diagram illustrating the architecture, operation, and/or functionality of an embodiment of the memory channel interleaver 106. The memory channel interleaver 106 receives the interleave signals 138 from MMU 103 and input on the SoC bus 107. The memory channel interleaver 106 provides outputs to memory controllers 108 and 116 (memory channels CHO and CH1, respectively) via separate memory controller buses. The memory controller buses may run at half the rate of the SoC bus 107 with the net data throughput being matched. Address mapping module(s) 750 may be programmed via the SoC bus 107. The address mapping module(s) 750 may configure and access the address memory map 400, as described above, with the linear regions 402 and 408 and the interleaved region 404 and 406.

The interleave signals 138 received from the MMU 103 signal that the current write or read transaction on SoC bus 107 is, for example, linear, interleaved every 512 byte addresses, or interleaved every 1024 byte addresses. Address mapping is controlled via the interleave signals 138, which takes the high address bits 756 and maps them to CH0 and CH1 high addresses 760 and 762. Data traffic entering on the SoC bus 107 is routed to a data selector 770, which forwards the data to memory controllers 108 and 116 via merge components 772 and 774, respectively, based on a select signal 764 provided by the address mapping module(s) 750. For each traffic packet, a high address 756 enters the address mapping module(s) 750. The address mapping module(s) 750 generates the output interleaved signals 760, 762, and 764based on the value of the interleave signals 138. The select signal 764 specifies whether CH0 or CH1 has been selected. The merge components 772 and 774 may comprise a recombining of the high addresses 760 and 762, low address 705, and the CH0 data 766 and the CH1 data 768.

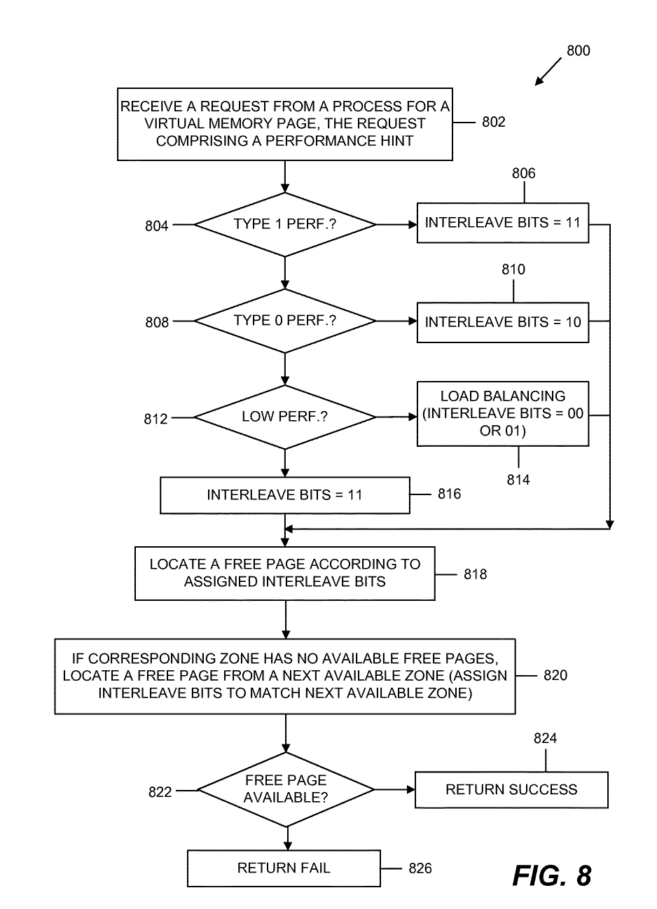

FIG. 8 illustrates an embodiment of a method 800 for allocating memory in the system 100. In an embodiment, the O/S, the MMU 103, other components in the system 100, or any combination thereof may implement aspects of the method 800. At block 802, a request is received from a process for a virtual memory page. As described above, the request may comprise a performance hint. If the performance hint corresponds to a first performance type 1 (decision block 804), the interleave bits may be assigned a value “11” (block 806). If the performance hint corresponds to a second performance type 0 (decision block 808), the interleave bits may be assigned a value “10” (block 810). If the performance hint corresponds to a low performance (decision block 812), the interleave bits may be assigned a value “00” or “01” using a load balancing scheme (block 814). In an embodiment, a load balancing scheme may attempt to assign all memory allocation requests from a same process ID to the same channel (“00” for CH0, or “01” for CH1), resulting in a uniform balancing across processes. In another embodiment, a load balancing scheme may assign memory allocation requests that originate within a predetermined time interval to the same channel. For example, during a time interval (0 to T), memory allocation requests may be assigned to channel 0. During a time interval (T to 2T), memory allocation requests may be assigned to channel 1, and so forth, resulting in a balancing across time. In another embodiment, a load balancing scheme may assign memory allocation requests to the channel that is least occupied, resulting in a balancing of capacity used. In a further embodiment, a load balancing scheme may assign memory allocation requests in groups, for example ten allocations to CH0 followed by ten allocations to CH1 and so forth. Another embodiment may actively monitor performance statistics such as the traffic bandwidth from each memory controller 108 or 116 during accesses to linear macroblocks, resulting in a balancing of traffic bandwidth. Allocations may also take into account the size of the allocation request, for example 64 KB to CH0 followed by 64 KB to CH1 and so forth. A hybrid scheme consisting of a combination of individual schemes may be employed. At block 816, the interleave bits may be assigned a value “11” as either a default value or in the event that a performance hint is not provided by the process requesting the virtual memory page.

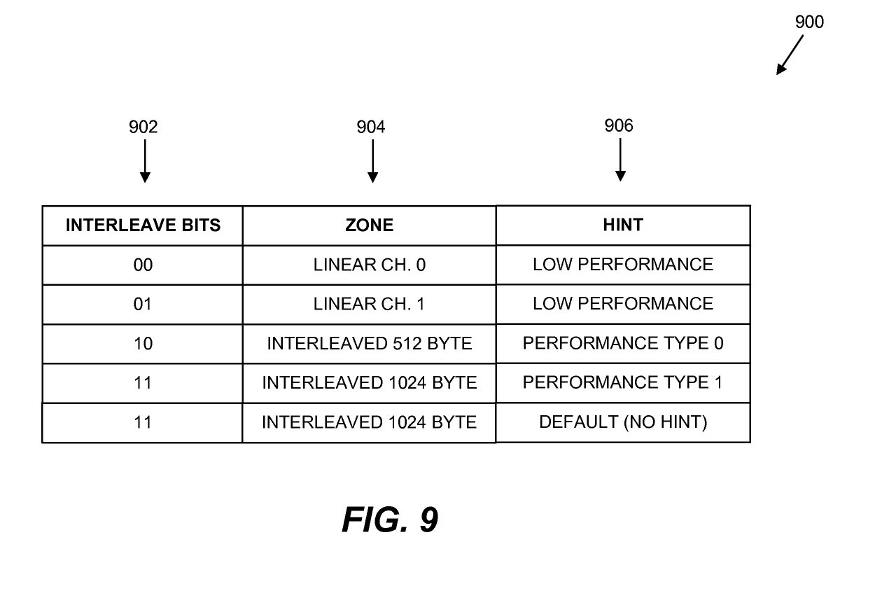

FIG. 9 illustrates an embodiment of a data table 900 for assigning the interleave bits (field 902) based on various performance hints (field 906). The interleave bits (field 902) defines the corresponding memory zones (field 904) as either linear CH0, linear CH1, interleaved type 0 (every 512 bytes), or interleaved type 1 (every 1024 bytes). In this manner, the received performance hint may be translated to an appropriate memory region.

Referring again to FIG. 8, at block 818, a free physical page is located in the appropriate memory region according to the assigned interleave bits. If a corresponding memory region does not have an available free page, a free page may be located from a next available memory region, at block 820, of a lower type. The interleave bits may be assigned to match the next available memory region. If a free page is not available (decision block 822), the method 800 may return a fail (block 826). If a free page is available, the method 800 may return a success (block 824).

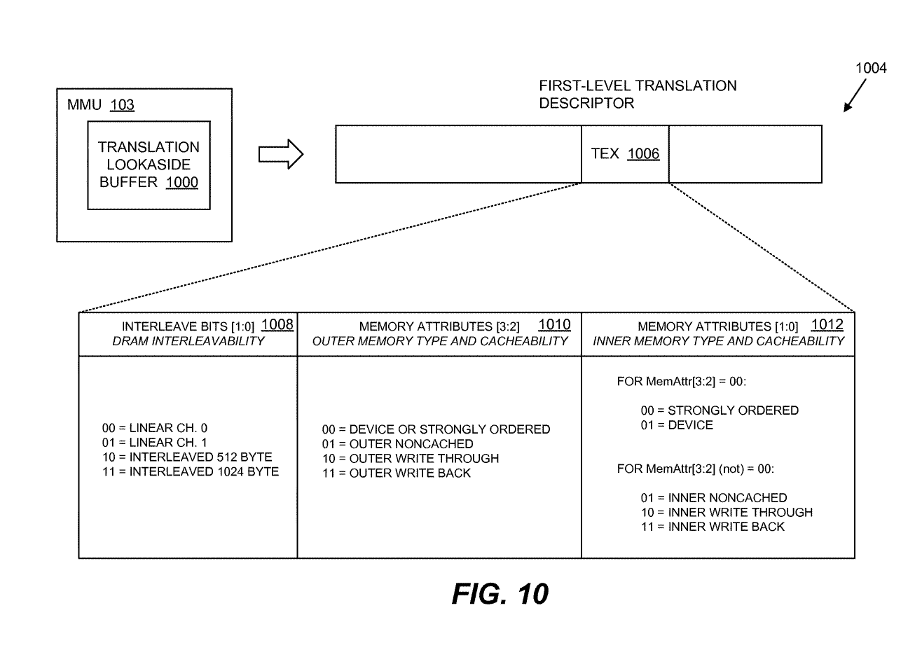

As mentioned above, the O/S kernel running on CPU 104 may manage the performance/interleave type for each memory allocation via the kernel memory map 132. To facilitate fast translation and caching, this information may be implemented in a page descriptor of a translation lookaside buffer 1000 in MMU 103. FIG. 10 illustrates an exemplary data format for incorporating the interleave bits in a first-level translation descriptor 1004 of the translation lookaside buffer 1000. The interleave bits may be added to a type exchange (TEX) field 1006 in the first-level translation descriptor 1004. As illustrated in FIG. 10, the TEX field 1006 may comprise sub-fields 1008, 1010, and 1012. Sub-field 1008 defines the interleave bits. Sub-field 1010 defines data related to memory attributes for an outer memory type and cacheability. Sub-field 1012 defines data related to memory attributes for an inner memory type and cacheability. The interleave bits provided in sub-field 1008 may be propagated downstream to the memory channel interleaver 106. When cache hierarchy is implemented in the CPU 104, the interleave bits may be driven properly when the data is evicted from the cache, the interleave bits can be saved in the cache tag to propagate the information.

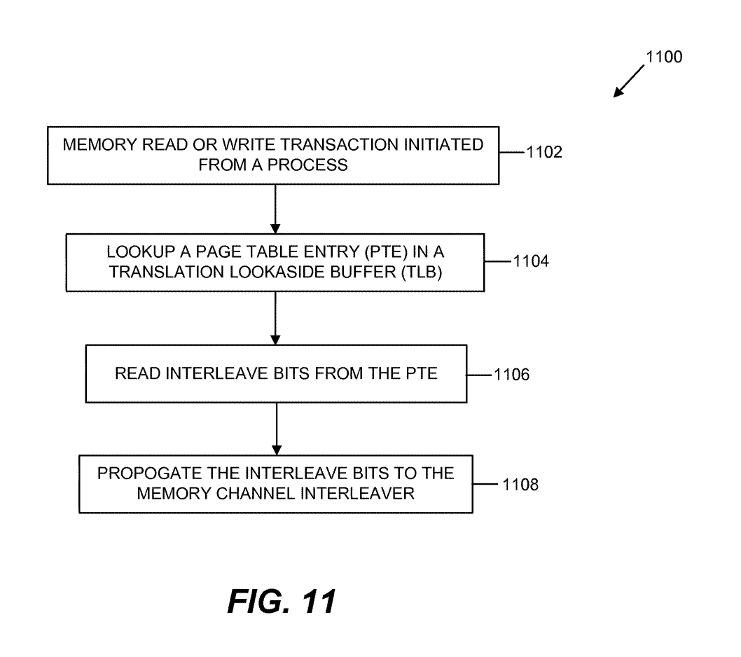

FIG. 11 is a flowchart illustrating an embodiment of a method 1100 comprising actions taken by the translation lookaside buffer 1000 and the memory channel interleaver 106 whenever a process performs a write or read to the memory devices 110 and 118. At block 1102, a memory read or write transaction is initiated from a process executing on CPU 104 or any other processing device. At block 1104, the page table entry is looked up in the translation lookaside buffer 1000. The interleave bits are read from the page table entry (block 1106), and propagated to the memory channel interleaver 106.

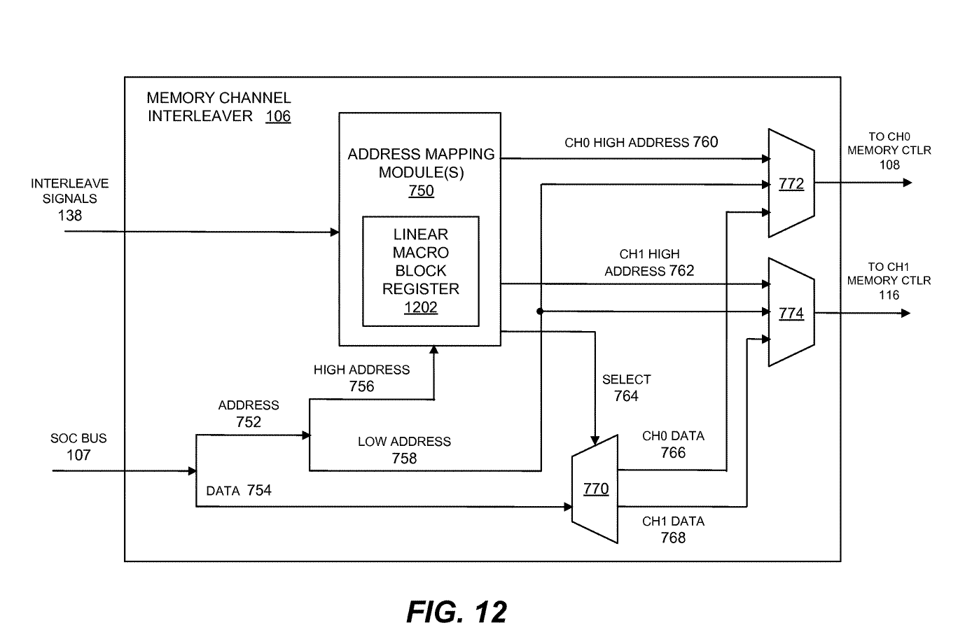

Referring to FIGS. 12-14, another embodiment of the memory channel interleaver 106 will be described. In this embodiment, the memory channel interleaver 106 further comprises a linear super macro block register 1202. Register 1202 and associated logic keeps track of which macro blocks in the system memory are interleaved and linear. When two or more linear macro blocks are physically adjacent, the address mapping module 750 may concatenate the adjacent linear macro blocks to maximize the amount of linear access in the system memory. It should be appreciated that a larger amount of linear access for a given channel will provide even more power savings.

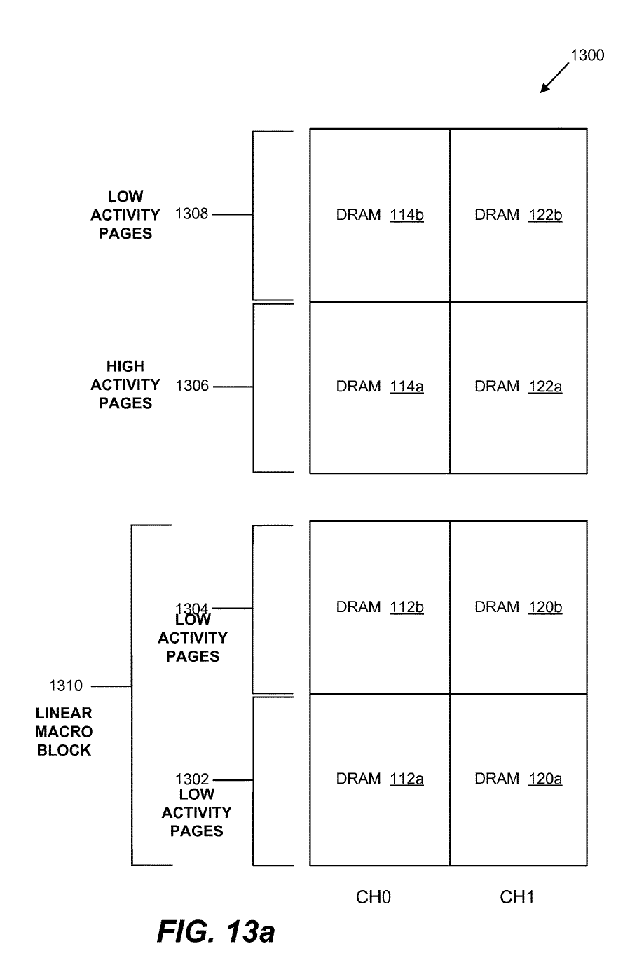

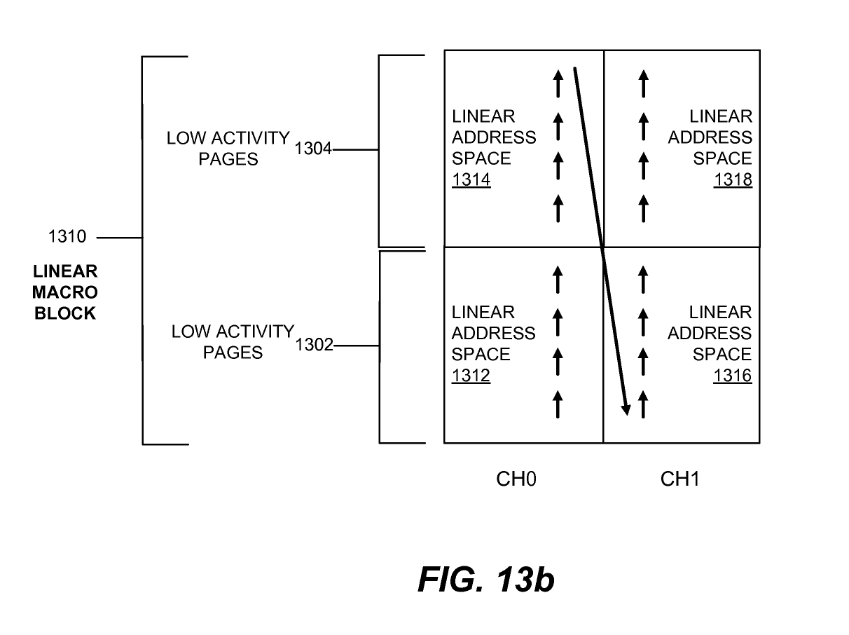

FIG. 13a illustrates an exemplary embodiment of a memory address map 1300 for concatenating adjacent linear macro blocks into a linear super macro block. As with the embodiment illustrated in FIGS. 4a and 4b, the system memory comprises memory devices 110 and 118. Memory device 110 comprises DRAM 112 and DRAM 114. Memory device 118 comprises DRAM 120 and DRAM 122. The system memory may be divided into fixed-size macro blocks of memory.

As illustrated in FIG. 13a, the system memory may comprise linear macro blocks 1302, 1304, and 1308 and an interleaved macro block 1306. The linear macro blocks 1302, 1304, and 1308 may be used for relatively low power use cases and/or tasks, and the interleaved macro block 1306 may be used for relatively high performance use cases and/or tasks. Each macro block comprises a separate allocated memory address space with a corresponding address range divided between the two memory channels CH0 and CH1. Interleaved macro block 1306 comprises an interleaved address space, and the linear macro blocks 1302, 1304, and 1308 comprise a linear address space.

Linear macro block 1302 comprises a first portion of DRAM 112 (112a) and a first portion of DRAM 120 (120a). DRAM portion 112a defines a linear address space 1312 for CH. 0. DRAM 120a defines a linear address space 1316 for CH. 1. Linear macro block 1304 comprises a second portion of DRAM 112 (112b) and a second portion of DRAM 120 (120b). DRAM portion 112b defines a linear address space 1314 for CH. 0. DRAM 120b defines a linear address space 1318 for CH. 1. As illustrated in FIG. 13a, linear macro blocks 1302 and 1304 are physically adjacent in memory.

Linear super macro block register 1202 may determine that the linear macro blocks 1302 and 1304 are physically adjacent in memory. In response, the system 100 may configure the physically adjacent blocks 1302 and 1302 as a linear super macro block 1310.

FIG. 13b illustrates the general configuration and operation of the linear super macro block 1310. In general, the linear address spaces for the physically adjacent macro blocks are concatenated to provide a larger range of consecutive memory addresses within each channel. As illustrated in FIG. 13b, linear address space 1312 (from linear macro block 1302) and linear address space 1314 (from linear macro block 1304) may be concatenated to provide a larger linear space for CH0. Similarly, linear address space 1316 (from linear macro block 1302) and linear address space 1318 (from linear macro block 1304) may be concatenated to provide a larger linear space for CH1. The vertical arrows illustrate that the consecutive addresses are assigned within CH0 until a top or last address in linear address space 1314 is reached. When the last available address in CH0 is reached, the next address may be assigned to the first address in linear address space 1316. Then, the allocation scheme follows the consecutive memory addresses in CH1 until a top address is reached.

In this manner, low performance use case data may be contained completely in either channel CH0 or channel CH1. In operation, only one of the channels CH0 and CH1 may be active while the other channel is placed in an inactive or “self-refresh” mode to conserve memory power. This can be extended to any number N memory channels.

FIG. 12 illustrates an embodiment of the memory channel interleaver 106 for concatenating linear macro blocks that are physically adjacent in system memory. The memory channel interleaver 106 receives the interleave signals 138 from MMU 103 and input on the SoC bus 107. The memory channel interleaver 106 provides outputs to memory controllers 108 and 116 (memory channels CH0 and CH1, respectively) via separate memory controller buses. The memory controller buses may run at half the rate of the SoC bus 107 with the net data throughput being matched. Address mapping module(s) 750 may be programmed via the SoC bus 107.

The address mapping module(s) 750 may configure and access the address memory map 1300, as described above, with the linear macro blocks 1302, 1304, and 1308 and the interleaved macro block 1306. The interleave signals 138 received from the MMU 103 signal that the current write or read transaction on SoC bus 107 is, for example, linear, interleaved every 512 byte addresses, or interleaved every 1024 byte addresses. Address mapping is controlled via the interleave signals 138, which takes the high address bits 756 and maps them to CH0 and CH1 high addresses 760 and 762. Data traffic entering on the SoC bus 107 is routed to a data selector 770, which forwards the data to memory controllers 108 and 116 via merge components 772 and 774, respectively, based on a select signal 764 provided by the address mapping module(s) 750.

For each traffic packet, a high address 756 enters the address mapping module(s) 750. The address mapping module(s) 750 generates the output interleaved signals 760, 762, and 764based on the value of the interleave signals 138. The select signal 764 specifies whether CH0 or CH1 has been selected. The merge components 772 and 774 may comprise a recombining of the high addresses 760 and 762, low address 705, and the CH0 data 766 and the CH1 data 768. Linear super macro block register 1202 keeps track of interleaved and non-interleaved macro blocks. When two or more linear macro blocks are physically adjacent, the address mapping module 750 is configured to provide linear mapping using the linear super macro block 1310.

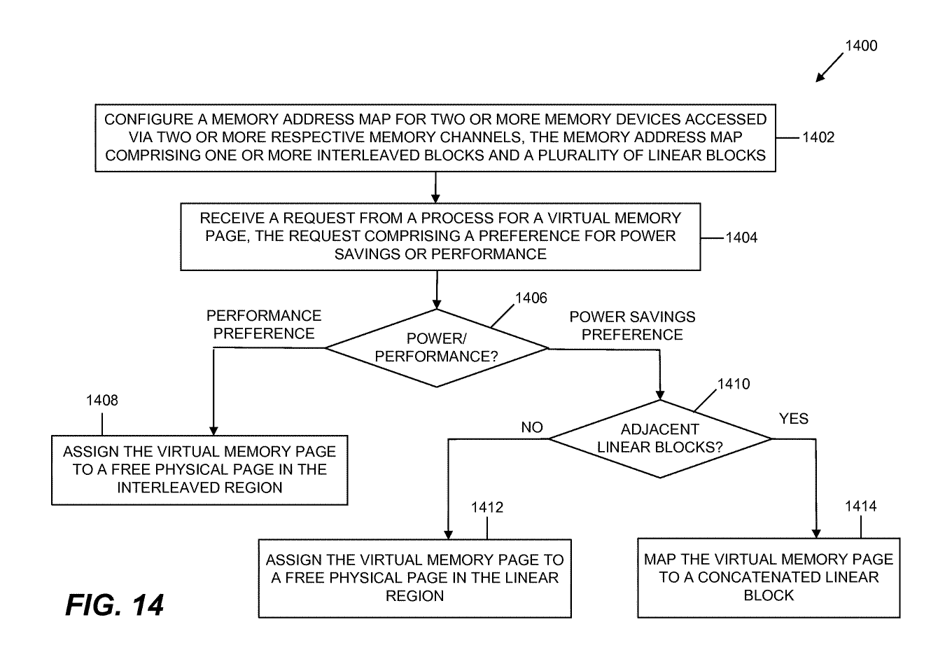

FIG. 14 is a flowchart illustrating an embodiment of a method 1400 for assigning virtual pages to the linear super macro block 1310. At block 1402, a memory address map is configured for two or more memory devices accessed via two or more respective memory channels. A first memory device 110 may be accessed via a first memory channel (CH. 0). A second memory device 118 may be accessed via a second memory channel (CH. 1). The memory address map is configured with one or more interleaved macro blocks for performing relatively higher performance tasks and two or more linear macro blocks for performing relatively lower performance tasks. At block 1404, a request is received from a process executing on a processing device (e.g., CPU 104) for a virtual memory page. The request may specify a preference, hint, or other information for indicating whether the process prefers to use interleaved or non-interleaved (i.e., linear) memory. The request may be received or otherwise provided to the MMU 103 (or other components) for processing, decoding, and assignment. At decision block 1406, if the preference is for performance (e.g., high activity pages), the virtual memory page may be assigned to a free physical page in an interleaved macro block (e.g., interleaved macro block 1306 in FIG. 13a).

If the preference is for power savings, at decision block 1410, the linear super macro block register 1202 (FIG. 12) may be accessed to determine if there are any physically adjacent linear macro blocks. If “yes”, the virtual memory page may be mapped to a concatenated linear block, such as, linear super macro block 1310. If “no”, the virtual memory page may be assigned to a free physical page one of the linear macro blocks.

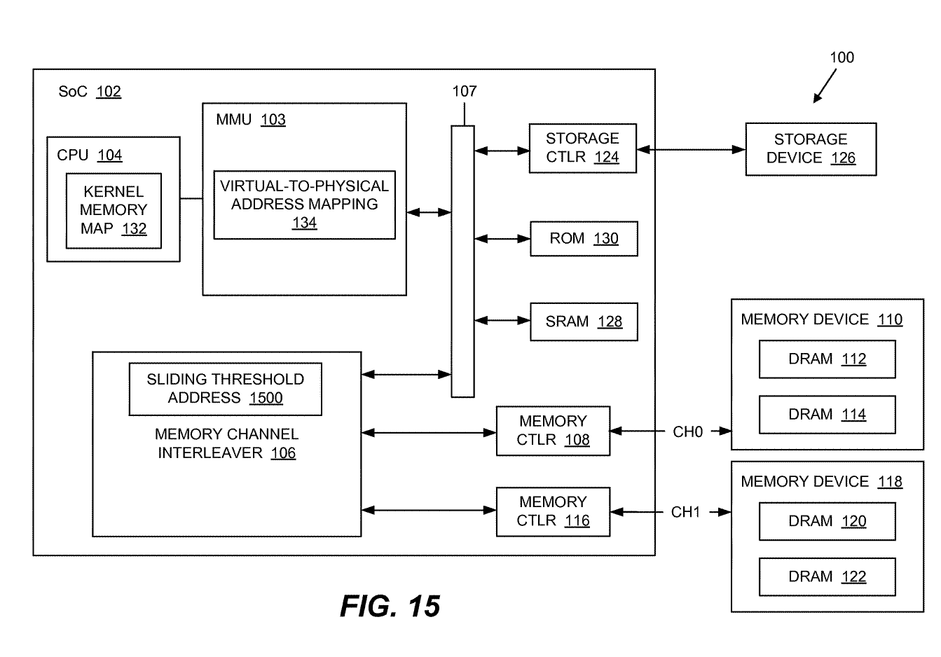

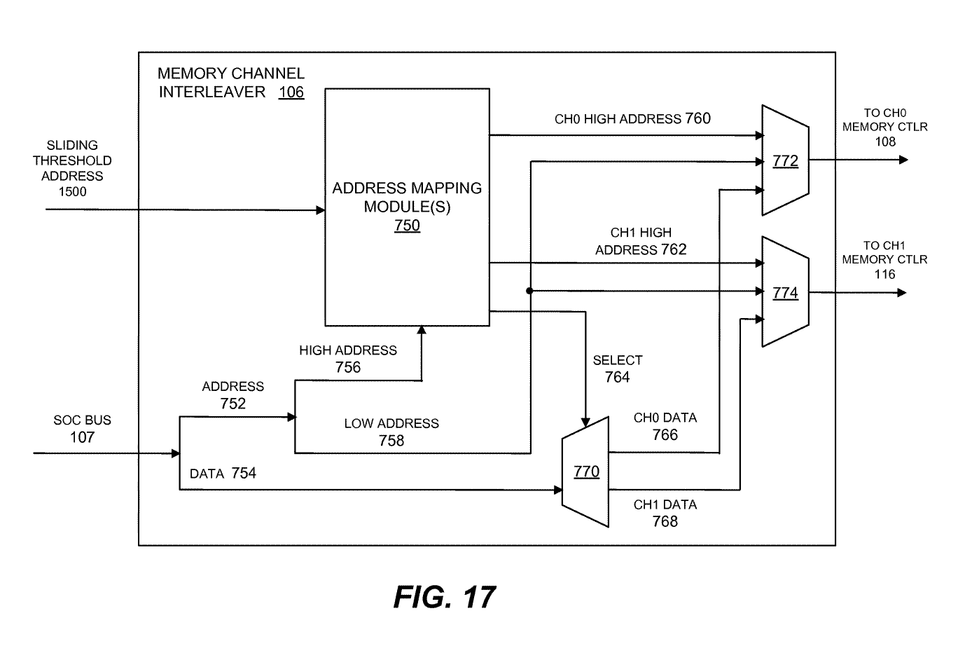

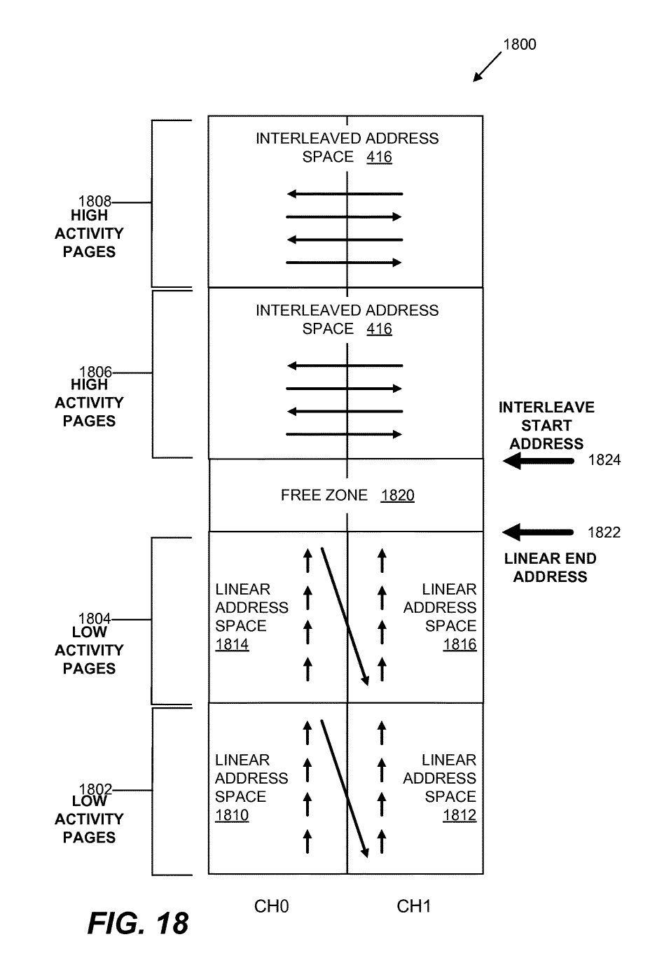

Referring to FIGS. 15-19, another embodiment of the system 100 will be described. In this embodiment, the system 100 provides macro block by macro block memory channel interleaving using a programmable sliding threshold address instead of interleave bits. FIG. 18 illustrates an exemplary embodiment of a memory address map 1800, which comprises a sliding threshold address for controlling channel interleaving. Memory address map 1800 may comprise linear macro blocks 1802 and 1804 and interleaved macro blocks 1806 and 1808. Linear macro block 1802 comprises a linear address space 1810 for CH0 and a linear address space 1812 for CH1. Linear macro block 1804 comprises a linear address space 1814 for CH0 and a linear address space 1816 for CH1. Interleaved macro blocks 1806 and 1808 comprise respective interleaved address spaces 416.

As further illustrated in FIG. 18, the sliding threshold address may define a boundary between linear macro block 1804 and interleaved macro block 1806. In an embodiment, the sliding threshold specifies a linear end address 1822 and an interleave start address 1824. The linear end address 1822 comprises the last address in the linear address space 1816 of linear macro block 1804. The interleaved start address 1824 comprises the first address in the interleaved address space corresponding to interleaved macro block 1806. A free zone 1820 between addresses 1822 and 1824 may comprise unused memory, which may be available for allocation to further linear or interleaved macro blocks. It should be appreciated that the system 100 may adjust the sliding threshold up or down as additional macro blocks are created. A memory allocator of the O/S may control the adjustment of the sliding threshold.

When freeing memory, unused macro blocks may be relocated into the free zone 1820. This may reduce latency when adjusting the sliding threshold. The memory allocator may keep track of free pages or holes in all used macro blocks. Memory allocation requests are fulfilled using free pages from the requested interleave type.

In an alternate embodiment, the free zone 1820 may be empty by definition. In that case, the interleave start address 1824 and the linear end address 1822 would be the same address and controlled by a single programmable register instead of two. It should be appreciated that the sliding threshold embodiments may extend to a plurality of memory zones. For example, the memory zones may comprise a linear address space, a 2-way interleaved address space, a 3-way interleaved address space, a 4-way interleaved address space, etc., or any combination of the above. In such cases, there may be additional programmable registers for the zone thresholds for each memory zone, and optionally for the free zones in between them.

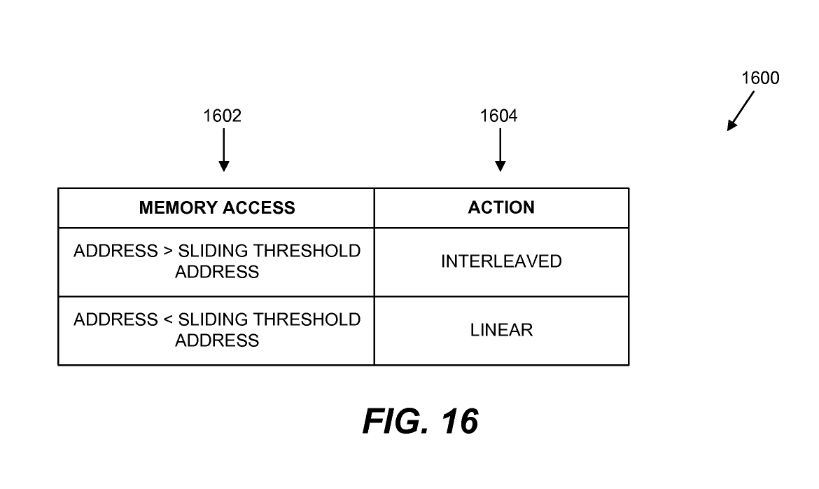

As illustrated in FIG. 16, memory access to interleaved or linear memory may be controlled, on a macro block basis, according to the sliding threshold address. In an embodiment, if the requested memory address is greater than the sliding threshold address (column 1602), the system 100 may assign the request to interleaved memory (column 1604). If the requested memory address is less than the sliding threshold address, the system 100 may assign the request to linear memory.

FIG. 15 illustrates an embodiment of the memory channel interleaver 106 for controlling channel interleaving via the sliding threshold address. The memory channel interleaver 106 receives the sliding threshold address 1500 from the O/S via register programming. The memory channel interleaver 106 provides outputs to memory controllers 108 and 116 (memory channels CH0 and CH1, respectively) via separate memory controller buses. The memory controller buses may run at half the rate of the SoC bus 107 with the net data throughput being matched. Address mapping module(s) 750 may be programmed via the SoC bus 107.

The address mapping module(s) 750 may configure and access the address memory map 1800, as described above, with the linear macro blocks 1802 and 1804 and the interleaved macro blocks 1806 and 1808. The sliding threshold address programmed by the O/S instructs the memory channel interleaver to perform interleaving for memory accesses above that address and to perform linear accesses below that address. As illustrated in FIG. 15, the address mapping module 750 may compare the sliding threshold address against the high address bits756, and then map them to CH0 and CH1 high addresses 760 and 762, respectively. Data traffic entering on the SoC bus 107 is routed to a data selector 770, which forwards the data to memory controllers 108 and 116 via merge components 772 and 774, respectively, based on a select signal 764 provided by the address mapping module(s) 750.

For each traffic packet, a high address 756 enters the address mapping module(s) 750. The address mapping module(s) 750 generates the output interleaved signals 760, 762, and 764 based on the value of the interleave signals 138. The select signal 764 specifies whether CH0 or CH1 has been selected. The merge components 772 and 774 may comprise a recombining of the high addresses 760 and 762, low address 705, and the CH0 data 766 and the CH1 data 768. It should be appreciated that linear macro blocks may be physically adjacent, in which case the address mapping module 750 may be configured to provide linear mapping using the linear super macro block 1310.

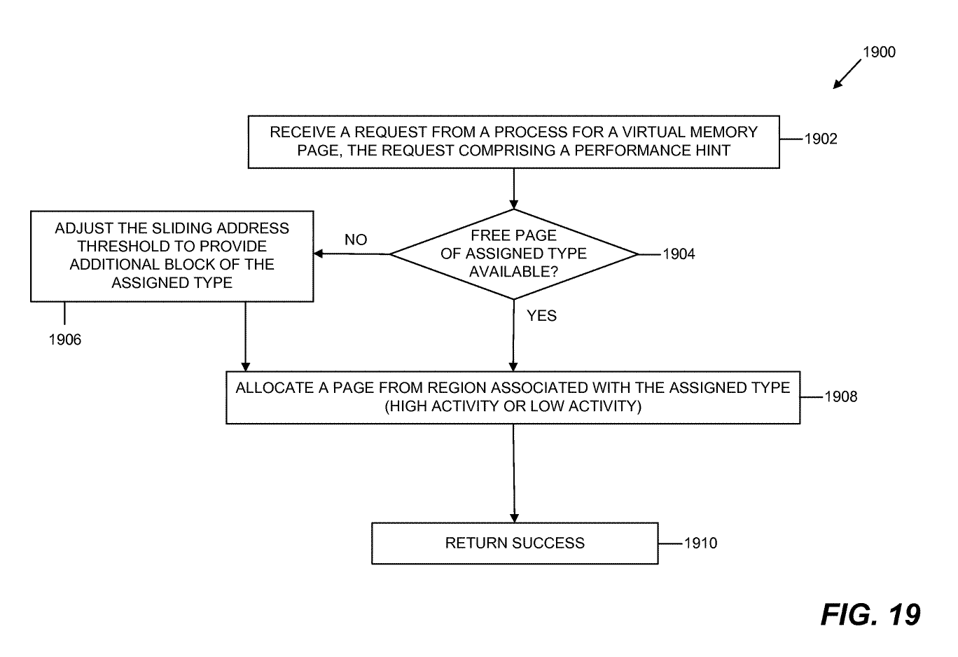

FIG. 19 is a flowchart illustrating an embodiment of a method 1900 implemented in the system of FIG. 15 for allocating memory according to the sliding threshold address. At block 1902, a request is received from a process for a virtual memory page. As described above, the request may comprise a performance hint. If a free page of the assigned type (interleaved or linear) is available (decision block 1904), a page may be allocated from the region associated with the assigned type (interleaved or linear). If a free page of the assigned type is not available, the sliding threshold address may be adjusted (block 1906) to provide an additional macro block of the assigned type. To provide the additional macro block of the desired type, the O/S may first need to free up a macro block from the memory region of the undesired type. This macro block may be physically adjacent to the memory region of the desired type. Standard O/S mechanisms (e.g., page freeing and page migration) may be used to free memory pages until such a free macro block is formed. When the free macro block is formed, the O/S may program the threshold register to grow the size of the desired memory region, while shrinking the size of the memory region of the undesired type. At block 1910, the method may return a success indicator (block 1910).

It should be appreciated that the memory allocation method may return success even if the page of the desired type is unavailable, and simply select a page from the memory region of the undesired type, and optionally defer the creation of the macro block of the desired type. This implementation may advantageously reduce the latency of the memory allocation. The O/S may remember which allocated pages are of the undesired type, keeping track of this information in its own data structures. At a later time that is convenient for the system or user, the O/S may do the macro block freeing operation to create free macro block(s) of the desired type. It can then relocate the pages from the undesired memory region to the desired memory region using standard O/S page migration mechanisms. The O/S may maintain its own count of how many pages are allocated in the undesired region, and trigger the macro block freeing and page migration when the count reaches a configurable threshold.

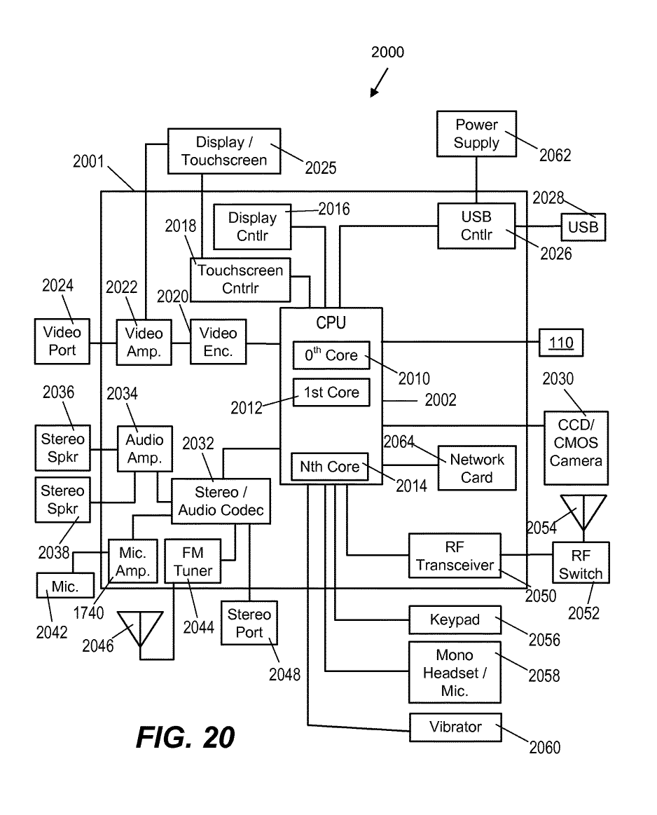

As mentioned above, the system 100 may be incorporated into any desirable computing system. FIG. 20 illustrates the system 100 incorporated in an exemplary portable computing device (PCD) 2000. The system 100 may be included on the SoC 2001, which may include a multicore CPU 2002. The multicore CPU 2002 may include a zeroth core 2010, a first core 2012, and an Nth core 2014. One of the cores may comprise, for example, a graphics processing unit (GPU) with one or more of the others comprising the CPU 104 (FIG. 1). According to alternate exemplary embodiments, the CPU 2002 may also comprise those of single core types and not one which has multiple cores, in which case the CPU 104 and the GPU may be dedicated processors, as illustrated in system 100.

A display controller 2016 and a touch screen controller 2018 may be coupled to the CPU 2002. In turn, the touch screen display 2025 external to the on-chip system 2001 may be coupled to the display controller 2016 and the touch screen controller 2018.

FIG. 20 further shows that a video encoder 2020, e.g., a phase alternating line (PAL) encoder, a sequential color a memoire (SECAM) encoder, or a national television system(s) committee (NTSC) encoder, is coupled to the multicore CPU 2002. Further, a video amplifier 2022 is coupled to the video encoder 2020 and the touch screen display 2025. Also, a video port 2024 is coupled to the video amplifier 2022. As shown in FIG. 20, a universal serial bus (USB) controller 2026 is coupled to the multicore CPU 2002. Also, a USB port 2028 is coupled to the USB controller 2026. Memory 110 and 118 and a subscriber identity module (SIM) card 2046 may also be coupled to the multicore CPU 2002. Memory 110 may comprise memory devices 110 and 118 (FIG. 1), as described above.

Further, as shown in FIG. 20, a digital camera 2030 may be coupled to the multicore CPU 2002. In an exemplary aspect, the digital camera 2030 is a charge-coupled device (CCD) camera or a complementary metal-oxide semiconductor (CMOS) camera.

As further illustrated in FIG. 20, a stereo audio coder-decoder (CODEC) 2032 may be coupled to the multicore CPU 2002. Moreover, an audio amplifier 2034 may coupled to the stereo audio CODEC 2032. In an exemplary aspect, a first stereo speaker 2036 and a second stereo speaker 2038 are coupled to the audio amplifier 2034. FIG. 20 shows that a microphone amplifier 1740 may be also coupled to the stereo audio CODEC 2032. Additionally, a microphone 2042 may be coupled to the microphone amplifier 1740. In a particular aspect, a frequency modulation (FM) radio tuner 2044 may be coupled to the stereo audio CODEC 2032. Also, an FM antenna 2046 is coupled to the FM radio tuner 2044. Further, stereo headphones 2048 may be coupled to the stereo audio CODEC 2032.

FIG. 20 further illustrates that a radio frequency (RF) transceiver 2050 may be coupled to the multicore CPU 2002. An RF switch 2052 may be coupled to the RF transceiver 2050 and an RF antenna 2054. As shown in FIG. 20, a keypad 2056 may be coupled to the multicore CPU 2002. Also, a mono headset with a microphone 2058 may be coupled to the multicore CPU 2002. Further, a vibrator device 2060 may be coupled to the multicore CPU 2002.

FIG. 20 also shows that a power supply 2062 may be coupled to the on-chip system 2001. In a particular aspect, the power supply 2062 is a direct current (DC) power supply that provides power to the various components of the PCD 2000 that require power. Further, in a particular aspect, the power supply is a rechargeable DC battery or a DC power supply that is derived from an alternating current (AC) to DC transformer that is connected to an AC power source.

FIG. 20 further indicates that the PCD 2000 may also include a network card 2064 that may be used to access a data network, e.g., a local area network, a personal area network, or any other network. The network card 2064 may be a Bluetooth network card, a WiFi network card, a personal area network (PAN) card, a personal area network ultra-low-power technology (PeANUT) network card, a television/cable/satellite tuner, or any other network card well known in the art. Further, the network card 2064 may be incorporated into a chip, i.e., the network card 388 may be a full solution in a chip, and may not be a separate network card.

It should be appreciated that one or more of the method steps described herein may be stored in the memory as computer program instructions, such as the modules described above. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A memory channel interleaving method with selective power or performance optimization, the method comprising:
configuring a memory address map for two or more memory devices accessed via two or more respective memory channels with an interleaved region and a linear region, the interleaved region comprising an interleaved address space for relatively higher performance tasks and the linear region comprising a linear address space for relatively lower power tasks;
receiving a request from a process for a virtual memory page, the request comprising a preference for power savings or performance; and
assigning the virtual memory page to a free physical page in the linear region or the interleaved region according to the preference for power savings or performance.

2. The method of claim 1, wherein the free physical page is assigned to the linear region if the preference is for power savings, and the free physical page is assigned to the interleaved region of the preference is for performance.

3. The method of claim 1, wherein the assigning the virtual memory page to the free physical page comprises:
a memory management unit adding one or more interleave bits to a page table entry.

4. The method of claim 1, further comprising:
configuring a page table entry with one or more interleave bits defining whether the virtual memory page is assigned to the linear region or the interleaved region.

5. The method of claim 4, further comprising:
receiving a further request for the virtual memory page;
accessing the page table entry;
determining the interleave bits; and
propagating the interleave bits to a memory channel interleaver.

6. The method of claim 1, wherein the linear region and the interleaved region comprise a fixed block of memory.

7. The method of claim 1, wherein the memory devices comprise dynamic random access memory (DRAM) devices.

8. The method of claim 1, wherein the preference for power savings or performance from the received request is translated by a memory allocator to an interleave type.

9. The method of claim 8, wherein the interleave type specifies one of the linear region and the interleaved region.

10. The method of claim 8, wherein the interleave type is provided to a channel interleaver in communication with one or more memory controllers.

11. A system for providing memory channel interleaving with selective power or performance optimization, the system comprising:
means for configuring a memory address map for two or more memory devices accessed via two or more respective memory channels with an interleaved region and a linear region, the interleaved region comprising an interleaved address space for relatively higher performance tasks and the linear region comprising a linear address space for relatively lower power tasks;
means for receiving a request from a process for a virtual memory page, the request comprising a preference for power savings or performance; and
means for assigning the virtual memory page to a free physical page in the linear region or the interleaved region according to the preference for power savings or performance.

12. The system of claim 11, wherein the free physical page is assigned to the linear region if the preference is for power savings, and the free physical page is assigned to the interleaved region of the preference is for performance.

13. The system of claim 11, wherein the means for assigning the virtual memory page to the free physical page comprises a memory management unit.

14. The system of claim 13, wherein the memory management unit is configured to add one or more interleave bits to a page table entry.

15. The system of claim 11, further comprising:
means for configuring a page table entry with one or more interleave bits defining whether the virtual memory page is assigned to the linear region or the interleaved region.

16. The system of claim 15, further comprising:
means for receiving a further request for the virtual memory page;
means for accessing the page table entry;
means for determining the interleave bits; and
means for propagating the interleave bits to a memory channel interleaver.

17. The system of claim 11, wherein the linear region and the interleaved region comprise a fixed block of memory.

18. The system of claim 11, wherein the memory devices comprise dynamic random access memory (DRAM) devices.

19. The method of claim 1, wherein the preference for power savings or performance from the received request is translated by a memory allocator to an interleave type which specifies one of the linear region and the interleaved region.

20. The method of claim 8, further comprising:
means for providing the interleave type to a channel interleaver in communication with one or more memory controllers.

21. A computer program product comprising a computer usable medium having a computer readable program code embodied therein, the computer readable program code adapted to be executed to implement a method for memory channel interleaving with selective power or performance optimization, the method comprising:
configuring a memory address map for two or more memory devices accessed via two or more respective memory channels with an interleaved region and a linear region, the interleaved region comprising an interleaved address space for relatively higher performance tasks and the linear region comprising a linear address space for relatively lower power tasks;
receiving a request from a process for a virtual memory page, the request comprising a preference for power savings or performance; and
assigning the virtual memory page to a free physical page in the linear region or the interleaved region according to the preference for power savings or performance.

22. The computer program product of claim 21, wherein the free physical page is assigned to the linear region if the preference is for power savings, and the free physical page is assigned to the interleaved region of the preference is for performance.

23. The computer program product of claim 21, wherein the assigning the virtual memory page to the free physical page comprises:
a memory management unit adding one or more interleave bits to a page table entry.

24. The computer program product of claim 21, wherein the method further comprises:
configuring a page table entry with one or more interleave bits defining whether the virtual memory page is assigned to the linear region or the interleaved region.

25. The computer program product of claim 24, wherein the method further comprises:
receiving a further request for the virtual memory page;
accessing the page table entry;
determining the interleave bits; and
propagating the interleave bits to a memory channel interleaver.

26. The computer program product of claim 21, wherein the linear region and the interleaved region comprise a fixed block of memory.

27. The computer program product of claim 21, wherein the memory devices comprise dynamic random access memory (DRAM) devices.

28. The computer program product of claim 21, wherein the preference for power savings or performance from the received request is translated by a memory allocator to an interleave type.

29. The computer program product of claim 28, wherein the interleave type specifies one of the linear region and the interleaved region.

30. The computer program product of claim 28, wherein the interleave type is provided to a channel interleaver in communication with one or more memory controllers.

31. A system for providing memory channel interleaving with selective power or performance optimization, the system comprising:
two or more memory devices; and
a system on chip (SoC) electrically coupled to the two or more memory devices, the SoC comprising a processing device and a memory management unit comprising logic configured to:
manage a memory address map for the two or more memory devices accessed via two or more respective memory channels with an interleaved region and a linear region, the interleaved region comprising an interleaved address space for relatively higher performance tasks and the linear region comprising a linear address space for relatively lower power tasks;
receive, from a process executing on the processing device, a request for a virtual memory page, the request comprising a preference for power savings or performance; and
assign the virtual memory page to a free physical page in the linear region or the interleaved region according to the preference for power savings or performance.

32. The system of claim 31, wherein the free physical page is assigned to the linear region if the preference is for power savings, and the free physical page is assigned to the interleaved region of the preference is for performance.

33. The system of claim 31, wherein the logic configured to assign the virtual memory page to the free physical page comprises:
logic configured to add one or more interleave bits to a page table entry.

34. The system of claim 31, wherein the memory management unit further comprises logic configured generate a page table entry with one or more interleave bits defining whether the virtual memory page is assigned to the linear region or the interleaved region.

35. The system of claim 34, wherein the memory management unit further comprises logic configured to:
receive a further request for the virtual memory page;
access the page table entry;
determine the interleave bits; and
propagate the interleave bits to a memory channel interleaver.

36. The system of claim 31, wherein the linear region and the interleaved region comprise a fixed block of memory.

37. The system of claim 31, wherein the memory devices comprise dynamic random access memory (DRAM) devices.

38. The system of claim 31, wherein the memory management unit comprises a memory allocator for translating the preference for power savings or performance from the received request to an interleave type.

39. The system of claim 38, wherein the interleave type specifies one of the linear region and the interleaved region.

40. The system of claim 38, wherein the interleave type is provided to a channel interleaver in communication with two or more memory controllers corresponding to the two or more memory devices.
